(19) United States
(12) Patent Application Publication
(10) Pub. No.: US 2008/0147566 A1
(43) Pub. Date: Jun. 19, 2008

(54) ONLINE AUCTION ANALYSIS AND RECOMMENDATION TOOL

(75) Inventor: Dale Malik, Atlanta, GA (US)

Correspondence Address: WITHERS & KEYS FOR BELL SOUTH, P. O. BOX 71355, MARIETTA, GA, 30007-1355, US

(73) Assignee: BellSouth Intellectual Property Corporation

(21) Appl. No.: 11/612,106

(22) Filed: Dec. 18, 2006

(51) Int. Cl. G06Q 40/00

(52) U.S. Cl. 705/36 R

(57) ABSTRACT

In a computer system, online auction data is retrieved by an auction analysis application program to generate recommendations for buying and selling auction items to auction participants. The auction participants may be either auction buyers or auction sellers. Profile data and auction item historical data associated with one or more auction participants is collected at the computer system from an auction website over a communication network. An output is then generated based on the profile data and the auction item historical data. The output may include recommendations for an auction seller and an auction buyer which may be utilized to increase sales of an auction item and to obtain a lowest price for an auction item.

### BACKGROUND

Auction websites, such as EBAY®, provide an online platform which enables participants to buy and sell goods and services over the Internet. Typically, auction items are traded through the use of auction-style listings in which successive bids are received starting with an initial price which is bid up by successive bidders. Auction items may also be traded through the use of fixed-price listings enabling participants immediate “buy it now” access to listed items. Auction websites enable buyers to place bids at any time and enables sellers to list items for a predetermined number of days (usually between 1 and 10). Auction websites may also enable users to manually search for statistics regarding auction items bought and sold, such as listing items which recently sold, when the items were sold, and sale prices for the sold items.

While auction websites provide limited statistics regarding auction items bought and sold, existing online auction platforms suffer from a number of drawbacks which hinder the auction process for buyers and sellers. For instance, existing online auction platforms fail to provide guidance to buyers regarding what is a reasonable price to pay for an item based on various historical factors such as the availability of the item over the course of a year. Similarly, existing online auction platforms fail to provide guidance to sellers regarding establishing a reasonable selling price for an auction item historical sale data for auction items such as the number of similar items previously sold over a user-defined period. Furthermore, existing online auction platforms also fail to enable a buyer or seller to simultaneously access a compilation of auction historical data in a single view to quickly determine buying and selling trends over the course of time. While existing online action platforms provide access to some historical auction data, this data must be manually accessed on a per auction or per item basis making the collection of the data for several auctions over a moderate to extended time period a labor and time intensive endeavor. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Various embodiments utilizing the techniques described herein solve the above and other problems by providing an auction analysis application program to generate recommendations for buying and selling auction items to auction participants on a networked computer system. The auction participants may be either auction buyers or auction sellers. Profile data and auction item historical data associated with one or more auction participants is collected at the computer system from an auction website over a communication network. An output is then generated based on the profile data and the auction item historical data. The output may include a popularity index, indicative of the popularity of an auction item, and an availability index, indicative of the availability of an auction item, over a predetermined period. The output may also include recommendations for an auction seller and an auction buyer which may be utilized to increase sales of an auction item and to obtain a lowest price for an auction item.

Other systems, methods, and/or computer program products according to various embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a computer network diagram illustrating aspects of exemplary computer systems utilized in and provided by various embodiments of the invention;

FIG. 2 is a computer system architecture diagram illustrating aspects of a client computer system utilized in and provided by various embodiments of the invention;

FIG. 3 is an illustrative output of the auction analysis application of FIGS. 1 and 2, which may be utilized to make buying and selling recommendations with respect to an auction item, in accordance with various embodiments of the invention;

FIG. 4 is a flow diagram illustrating aspects of a process for providing auction item analysis and auction participant recommendations utilizing auction parameter data in the computer network of FIG. 1, in accordance with various embodiments of the invention.

FIG. 5 is a flow diagram illustrating aspects of a process for automatically generating alerts which may be utilized in making buying and selling decisions with respect to an auction item, in accordance with various embodiments of the invention.

### DETAILED DESCRIPTION

As briefly described above, embodiments of the present invention are directed to providing an auction analysis application program to generate recommendations for buying and selling auction items to auction participants on a networked computer system. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

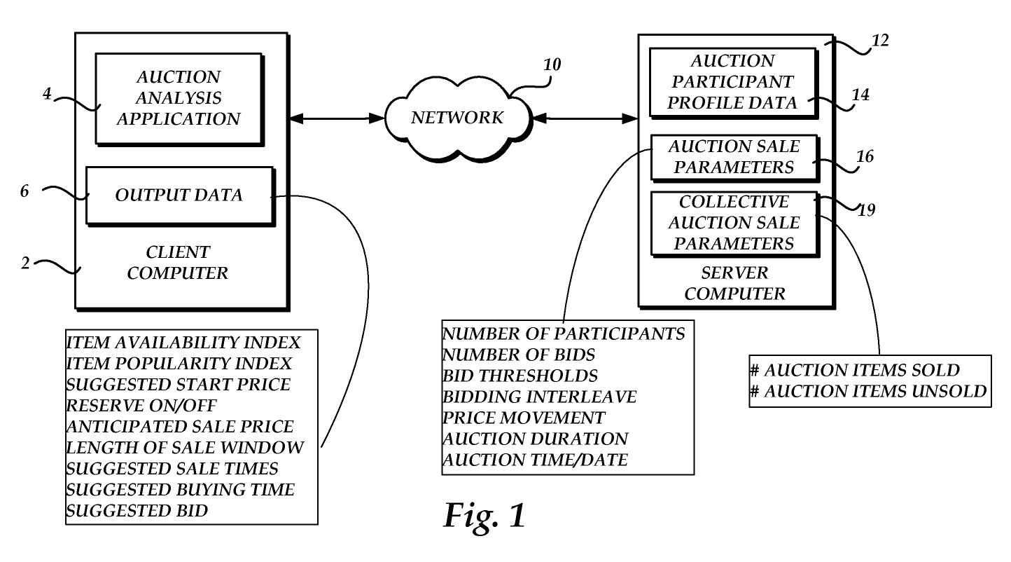

Referring now to the drawings, in which like numerals represent like elements through the several figures, various aspects of the present invention and an illustrative computing operating environment will be described. In particular, FIG. 1 and the corresponding discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Embodiments of the invention may be implemented as a computer process, a computing system, or as an article of manufacture, such as a computer program product or computer-readable media. The computer program product may be a computer storage media readable by a computer system and encoding a computer program of instructions for executing a computer process. The computer program may also be a propagated signal on a carrier readable by a computing system and encoding a computer program of instructions for executing a computer process.

Referring now to FIG. 1, an illustrative operating environment for the several embodiments utilizing the techniques described herein will be described. As shown in FIG. 1, a network 10 interconnects a client computer 2 and a server computer 12. It should be appreciated that the network 10 may comprise any type of computing network, including a local area network or a wide area network, such as the Internet. The network 10 provides a medium for enabling communication between the client computer 2, the server computer 12, and potentially other computer systems connected to or accessible through the network 10. The client computer 2 may comprise a general purpose desktop computer, laptop computer, or other computing device (including, but not limited to, cellular telephones, Personal Digital Assistants, and the like) capable of executing one or more application programs.

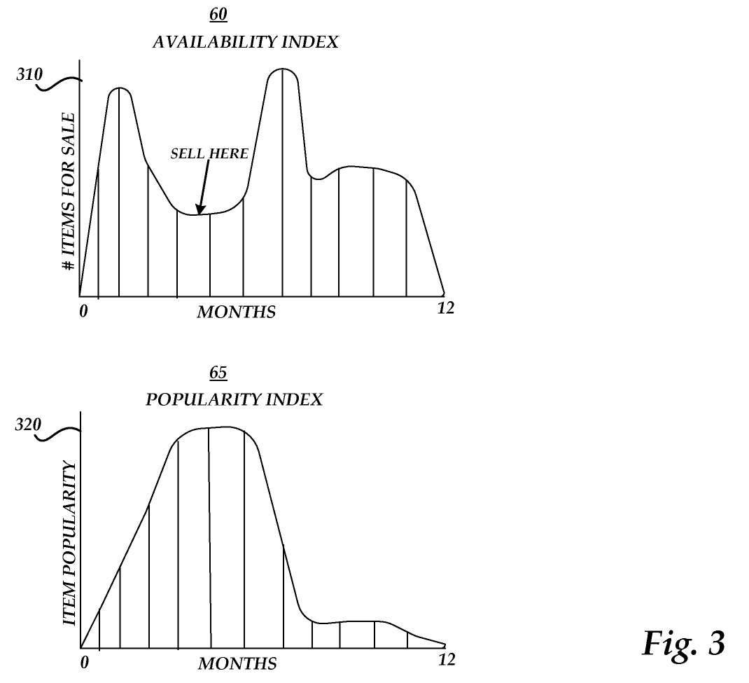

In particular, according to various embodiments, among others, utilizing the technical features described herein, the client computer 2 is operative to execute an auction analysis application 4. The auction analysis application 4 provides functionality for providing auction item analysis and generating output data 6, which may include auction participant recommendations. An auction participant may be a seller who offers one or items for sale over a predetermined period in an auction, or a buyer who purchases items for sale in an auction by either submitting one or more bids in an attempt to be the highest bidder or purchases items for a predetermined price (e.g., a “Buy it Now” price) set by the seller in an auction. The output data 6 may include, but is not limited to, the following outputs: an item availability index which is a historical measure of the availability of an auction item over a predetermined period, an item popularity index which is a historical measure of the popularity of an auction item over a predetermined period, a suggested starting price for selling an auction item, whether or not to set a “reserve” price (e.g., a minimum price at which a seller is obligated to sell an auction item), an anticipated sale price for an auction item, a suggested sale window for selling an auction item, suggested sale times (e.g., time and date) for selling an auction item, a suggested buying time for buying an auction item, and a suggested bid price for a buyer to bid on an auction item. The auction analysis application 4 and the output data 6 generated therefrom, will be described in greater detail below with respect to FIGS. 3-6.

The server computer 12 may be a web server operative to execute one or more software applications (not shown) for hosting an auction website for buying and selling auction items, such as the auction website provided by the EBAY® CORPORATION of San Jose, Calif. It should be appreciated however, that in accordance with other embodiments, among others, utilizing the technical features described herein, the server 12 may be utilized to host other auction websites from other providers. The server 12 stores auction participant profile data 14, auction sale parameters 16, and collective auction sale parameters 19. The auction participant profile data 14 may include account and historical usage information for an auction buyer or seller which is retrieved by the auction analysis application 4 from an auction website. The buyer profile data may include, for example, whether the buyer is a “Buy It Now” only buyer, biding frequency (e.g., one bid per auction versus many), preferred payment method, preferred auction type, when bids are typically made (e.g., time of day and days of the week), the buyer's “wish list” (i.e., a list of items the buyer is interested in purchasing or bidding on which is submitted to the auction website for alerting the buyer when one or more of the items is for sale), etc. The seller profile data may include, for example, whether the seller is a “Power” or high-volume seller, the seller's current inventory of auction items, the average length of the seller's auctions (e.g., 7-day auctions or 10-day auctions), etc.

The auction sale parameters 16 may include historical data retrieved by the auction analysis application 4 from an auction website for an item sold in a single auction by a seller, including the number of participants in the auction, the number of bids received, bid thresholds (i.e., the minimum and maximum bids made in the auction), bidding interleave (i.e., upbidding), price or bid movement (e.g., price spread, starting or first bit, etc.), the duration of the auction, the ending time and date of the auction, and the number of active bids at the ending time and date of the auction. The collective auction sale parameters 19 may include historical data retrieved by the auction analysis application 4 from an auction website for an item sold in multiple auctions by one or more sellers, including the number of auction items sold and the number of auction items unsold (e.g., items which did not receive bids or auctions in which a reserve price was not met).

It should be understood that in some embodiments, among others, the auction analysis application 4 may comprise an agent program configured for retrieving the auction participant profile data 14, the auction sale parameters 16, and the collective auction sale parameters 19, from the server computer 12. As will be understood by those skilled in the art, an agent is a computer program that may be configured to perform information gathering and task processing including searching the Internet for certain types of information. For instance, an agent program module in the auction analysis application 4 may be configured to track the number of visitors to an auction webpage who view a particular item put on sale by a seller.

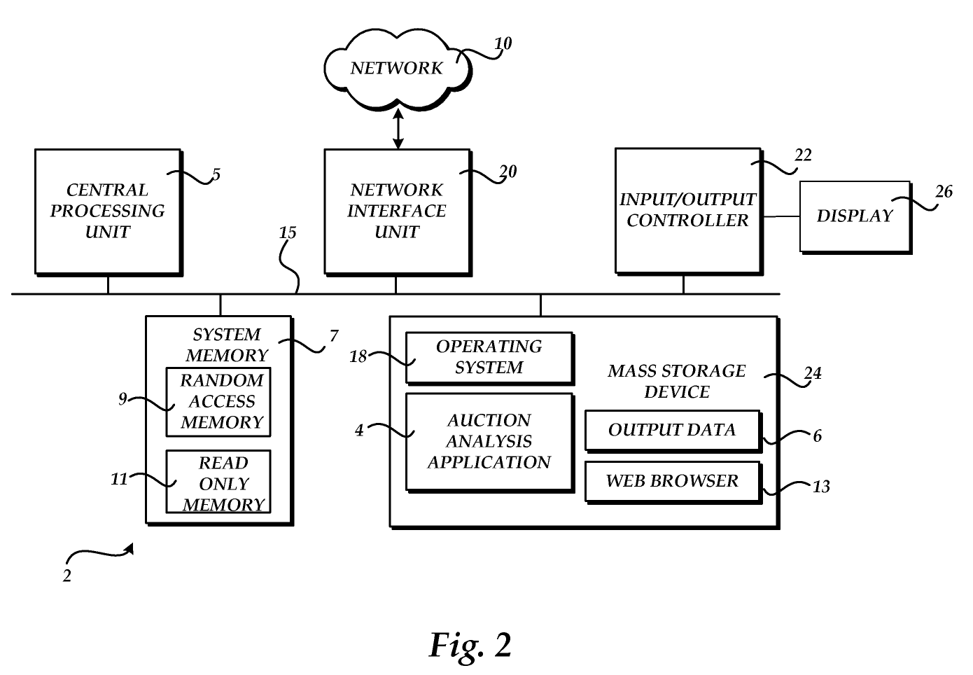

Referring now to FIG. 2, an illustrative computer architecture for the client computer 2 utilized in various embodiments of the invention, among others, will be described. The computer architecture shown in FIG. 2 illustrates a conventional desktop or laptop computer, including a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The client computer 2 further includes a mass storage device 24 for storing an operating system 18, application programs, and data, which will be described in greater detail below.

The mass storage device 24 is connected to the CPU 5 through a mass storage controller (not shown) connected to the bus 12. The mass storage device 24 and its associated computer-readable media provide non-volatile storage for the client computer 2. Although the description of computer-readable media contained herein refers to a mass storage device, such as a hard disk or CD-ROM drive, it should be appreciated by those skilled in the art that computer-readable media can be any available media that can be accessed by the client computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the client computer 2.

According to various embodiments of the invention, the client computer 2 may operate in a networked environment using logical connections to remote computers through the network 10. The client computer 2 may connect to the network 10 through a network interface unit 20 connected to the bus 12. It should be appreciated that the network interface unit 20 may also be utilized to connect to other types of networks and remote computer systems. The client computer 2 may also include an input/output controller 22 for receiving and processing input from a number of other devices, including a keyboard, mouse, or electronic stylus (not shown in FIG. 2). Similarly, an input/output controller 22 may provide output to a display screen 26, a printer, or other type of output device.

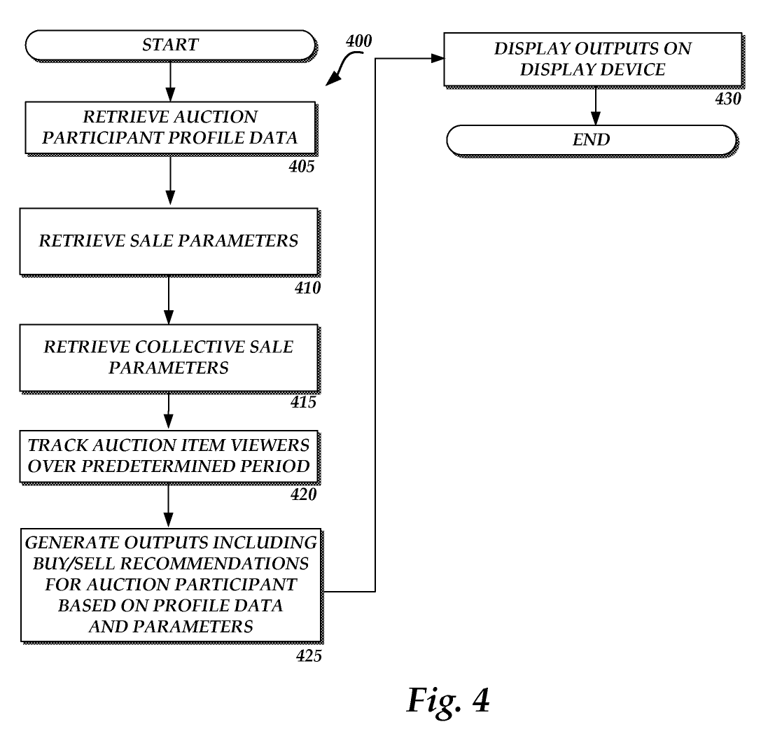

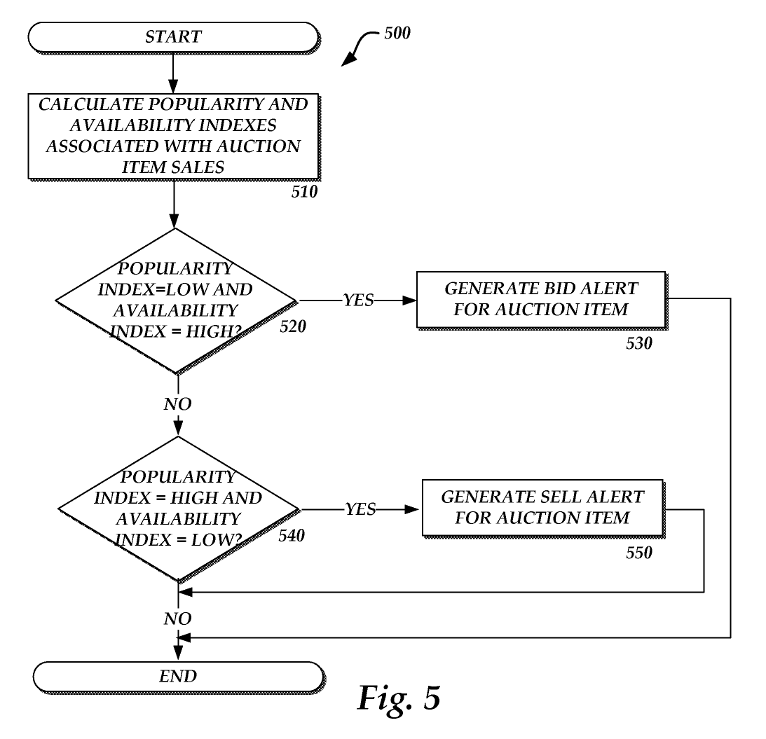

As mentioned briefly above, a number of program modules and data files may be stored in the mass storage device 24 and RAM 9 of the computer 2, including an operating system 18 suitable for controlling the operation of a networked personal computer. The mass storage device 24 and RAM 9 may also store one or more program modules such as web browser 13, for accessing an auction website hosted by the server 12, and the auction analysis application 4, as described above. The mass storage device 24 and RAM 9 may also store the output data 6 which may be generated by the auction analysis application 4 and which may include auction participant recommendations for buying and selling auction items. Illustrative routines describing the generation of the output data 6 will be described in greater detail below with respect to FIGS. 4-5.

It should be understood that in various embodiments of the invention, among others, the auction application program 4 is also operative to generate a graphical display on the display device 26 for viewing the output 6. An illustrative display of the output 6 generated by the auction analysis application 4, will be described in greater detail below with respect to FIG. 3.

Referring now to FIG. 3, an illustrative output generated by the auction analysis application 4 will be described for making buying and selling recommendations with respect to an auction item, in accordance with various embodiments of the invention, among others. FIG. 3 shows a set of output graphs including an Availability Index 60 and a Popularity Index 65, with respect to an auction item for sale over a twelve month period. It should be understood that, in accordance with various embodiments, among others, that a user of the auction analysis application 4 may select any predetermined period for generating an output including a number of hours, days, weeks or months. The Availability Index 60 shows how the number of auction items for sale changes over the predetermined period. In particular, the Availability Index 60 may inform an auction buyer or seller of a time of year when there is a relatively large number of a particular auction item for sale and of a time of year when there is a relatively small number of a particular auction item for sale. The auction analysis application 4 may determine the Availability Index 60 for an auction item from the collective auction sale parameters 19 which includes historical data indicating the number of auction items sold or unsold.

The Popularity Index 65 shows the trend in the popularity of the same auction item tracked in the Availability Index, over the same predetermined period. It should be understood that the auction analysis application 4 may determine the popularity of an auction item by calculating a weighted ratio between the number of bidders for an auction item and the number of viewers who visit a webpage for the auction item but who do not place a bid. It should be appreciated that in various implementations of the invention, the number of viewers is more heavily weighted than the number of bidders when calculating the Popularity Index 65. It should be further appreciated that the auction analysis application 4 may generate an indicator corresponding to an identified period on the Availability and Popularity Indexes 60 and 65 when conditions correspond to a favorable buying or selling opportunity for an auction buyer or seller. For instance, if the Availability Index 60 for a period is low and the Popularity Index 65 for the same period is high, the auction analysis application 4 may generate a “Sell Here” indicator pointing to the identified period as one which is beneficial to a seller (i.e., the seller may be able to sell an auction item for a higher price during this period because the demand for the item exceeds the supply of the item).

As will be described in greater detail below with respect to FIG. 5, a buyer or seller may utilize the Availability Index 60 and the Popularity Index 65 to determine a period in which to buy or sell an auction item. For instance, during a period when the availability of an auction item is low and the popularity of the auction item is high, a seller may determine that the demand for the auction item is high and place the auction item for sale on an auction website at a higher price. Conversely, during a period when the availability of an auction item is high and the popularity of the auction item is low, a buyer may determine that the demand for a large inventory of the auction items is low and make a low bid based on the assumption that a seller will accept a lower price to liquidate excess inventory.

Referring now to FIG. 4, an illustrative routine 400 will be described illustrating a process performed by the performed by the auction analysis application 4 for providing auction item analysis and auction participant recommendations. When reading the discussion of the routines presented herein, it should be appreciated that the logical operations of various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated in FIGS. 4-5, and making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims set forth herein.

The routine 400 begins at operation 405, where the auction analysis application 4 retrieves the auction participant profile data 14 from the server 12. As discussed above with respect to FIG. 1, the auction analysis application 4 may comprise an agent for retrieving buyer and/or seller profile data from an auction website.

From operation 405, the routine 400 continues to operation 410, where the auction analysis application 4 retrieves the auction sale parameters 16 from the server 12. As discussed above with respect to FIG. 1, the auction sale parameters 16 may include historical data for an item sold in a single auction by a seller, such as the number of participants in the auction, the number of bids received, etc.

From operation 410, the routine 400 continues to operation 415, where the auction analysis application 4 retrieves the collective auction sale parameters 19 from the server 12. As discussed above with respect to FIG. 1, the auction sale parameters 16 may include historical data for an item sold in multiple auctions by one or more sellers, including the number of auction items sold and unsold over a predetermined period.

From operation 415, the routine 400 continues to operation 420, where the auction analysis application 4 tracks auction item viewers over a predetermined time period. In particular, the auction analysis application 4, using an agent program, may access an online auction website to track the number of visitors to a web page describing an auction item for sale by a seller. Software programs for calculating and tracking visitors to a web page are well known to those skilled in the art.

From operation 420, the routine 400 continues to operation 425, where the auction analysis application 4 generates outputs, including auction item buying and selling recommendations, for an auction participant based on the auction participant profile data 12 and the parameters 16 and 19 retrieved from the server 12. In particular, the auction analysis application 4 may generate and calculate the availability and popularity indexes discussed above with respect to FIG. 3. It will be appreciated that the auction analysis application 4 may utilize the availability and popularity index data to generate additional outputs such as a suggested starting price for selling an auction item, whether or not to set a “reserve” price, an anticipated sale price for an auction item, a suggested sale window for selling an auction item, suggested sale times for selling an auction item, a suggested buying time for buying an auction item, and a suggested bid price for a buyer to bid on an auction item. For instance, the auction analysis application 4 may generate a recommendation for a suggested sale time for selling an auction item by determining, from the availability and popularity index data, a time of year when the demand for the auction item is relatively high and the seller's inventory (previously retrieved in the auction participant profile data 14) is relatively low and concurrently recommend a long sale window (e.g., a 10-day auction versus a 7-day or 3-day auction) and that an existing selling price for the item (obtained from the auction participant profile data 14) be increased. If the popularity index data indicates that the popularity for an auction item at a certain time of year is low, the auction analysis application 4 may generate a recommendation for a seller to set a reserve price for the auction item or alternatively to set a high starting price. If the popularity index data and the availability index data indicate that the popularity and availability of an auction item for a certain time of year is high, then the auction analysis application 4 may generate a recommendation for a short sale window (e.g., a 3-day auction) for the auction item to take advantage of a high demand in a high volume market and further generate a recommendation to maintain an existing selling price. If the popularity index data and the availability index data indicate that the popularity and availability of an auction item for a certain time of year is low (e.g., Sunday nights in August), then the auction analysis application 4 may generate a “buy” recommendation for a buyer because the seller is likely to sell the auction item for a lower price when there is a relatively high inventory in the face of a relatively low demand.

From operation 425, the routine 400 continues to operation 430, where the auction analysis application 4 displays the output generated at operation 430 on the display device 26. In accordance with various embodiments, among others, the displayed output may include the Availability and Popularity Index graphs 60 and 65 discussed above with respect to FIG. 3. In accordance with other embodiments, the auction analysis application 4 may also generate a “Dashboard” (not shown) which is a graphical display listing the various buying and selling recommendations discussed above. From operation 430, the routine 400 then ends.

Referring now to FIG. 5, an illustrative routine 500 will be described illustrating a process performed by the performed by the auction analysis application 4 for automatically generating alerts which may be utilized in making buying and selling decisions with respect to an auction item. The routine 500 begins at operation 510, where the auction analysis application 4 calculates the popularity and availability indexes associated with an auction item as discussed in detail above with respect to FIG. 3.

From operation 510, the routine 500 continues to operation 520 where the auction analysis application 4 determines a popularity index value and an availability index value for a specified period. If, at operation 520, the auction analysis application 4 determines that the popularity index is low and the availability index is high for the specified period, then the routine 500 continues to operation 540 where the auction analysis application 4 generates a bid alert for the auction item. From operation 530, the routine 500 then ends.

If, at operation 520, the auction analysis application 4 does not determine that the popularity index is low and the availability index is high for the specified period, then the routine 500 branches to operation 540 where the auction analysis application 4 determines if the popularity index is high and the availability index is low for the specified period. If so, then the auction analysis application 4 continues to operation 550 where the auction analysis application 4 generates a sell alert for the auction item. From operation 540, the routine 500 then ends. If at operation 540, the auction analysis application 4 does not determine that the popularity index is high and the availability index is low for the specified period, the routine 500 then ends.

Those skilled in the art will appreciate that the auction analysis application 4 may communicate the buy and sell alerts as messages to one or more auction participants using a number of communication methods including, but not limited to, electronic mail (“E-mail”), short message service (“SMS”), electronic paging, or as an on-screen notification on the display screen 26 for display to an auction participant when he or she accesses the auction analysis application 4 on the client computer 2.

Based on the foregoing, it should be appreciated that various embodiments of the present invention are directed to providing an auction analysis application program to generate recommendations for buying and selling auction items to auction participants on a networked computer system. It will be apparent by those skilled in the art that various modifications or variations may be made in the present invention without departing from the scope or spirit of the invention. Other embodiments of the present invention will be apparent to those skilled in the art from consideration of the specification and practice of the invention disclosed herein.

I claim:

1. A method for providing at least one of an auction item analysis and auction participant recommendations utilizing auction parameter data, comprising:
retrieving participant profile data for an auction participant on a computer system;
retrieving a first plurality of parameters comprising sale information for an auction item associated with the auction participant on the computer system;
retrieving a second plurality of parameters comprising collective sale information for a plurality of auction participants associated with the auction item on the computer system; and
generating an output on the computer system based on the participant profile data, the first plurality of parameters, and the second plurality of parameters, the output comprising at least one auction decision recommendation associated with buying and selling the auction item in at least one online auction hosted by one or more auction websites.

2. The method of claim 1, wherein generating an output further comprises:
calculating a popularity index and an availability index associated with sales of the auction item over a predetermined period; and
displaying the output on a display device of the computer system.

3. The method of claim 1, wherein retrieving participant profile data for an auction participant comprises retrieving seller profile data.

4. The method of claim 1, wherein retrieving participant profile data for an auction participant comprises retrieving buyer profile data.

5. The method of claim 2, wherein generating an output further comprises:
automatically analyzing the popularity index and the availability index for the auction item over the predetermined period;
if the popularity index is low and the availability index is high, then generating an alert for the auction participant to bid on the auction item; and
if the popularity index is high and the availability index is low, then generating an alert for the auction participant to offer the auction item for sale.

6. The method of claim 2 further comprising tracking a number of viewers for the auction item on the auction website over the predetermined period.

7. The method of claim 6, wherein generating an output based on the participant profile data, the first plurality of parameters, and the second plurality of parameters comprises calculating a weighted ratio based at least on a number of bidders for the auction item and the tracked number of viewers for the auction item on the auction website over the predetermined period.

8. The method of claim 1, wherein generating an output further comprises generating at least one of a suggested starting sale price, an anticipated sale price, an optimum sale window, and a suggested sale period.

9. The method of claim 1, wherein generating an output further comprises generating at least one of a suggested buying period and a suggested starting bid amount.

10. The method of claim 2, wherein retrieving a first plurality of parameters comprising sale information for an auction item associated with the auction participant comprises retrieving, over the predetermined period, at least one of a total number of bidders, a total number of bids, a bid threshold, a price interval, an auction duration, and an ending time and date associated with an auction.

11. The method of claim 2, wherein retrieving a second plurality of parameters comprising collective sale information for a plurality of auction participants associated with the auction item comprises retrieving, over the predetermined period, at least one of a total number of the auction item sold and a total number of the auction item which went unsold.

12. A computer-readable medium containing computer-executable instructions, which, when executed on a computer, will cause the computer to perform a method of providing at least one of an auction item analysis and auction participant recommendations utilizing auction parameter data, the method comprising:
retrieving participant profile data for an auction participant;
retrieving a first plurality of parameters comprising sale information for an auction item associated with the auction participant;
retrieving a second plurality of parameters comprising collective sale information for a plurality of auction participants associated with the auction item;
tracking a number of viewers for the auction item over a predetermined period;
generating an output based on the participant profile data, the first plurality of parameters, and the second plurality of parameters, the output comprising a popularity index and an availability index associated with sales of the auction item over the predetermined period and at least one recommendation associated with buying and selling the auction item in at least one online auction hosted by one or more auction websites; and
displaying the output on a display device of the computer.

13. The computer-readable medium of claim 12, wherein retrieving participant profile data for an auction participant comprises retrieving seller profile data, the seller profile data comprising an inventory of the auction item.

14. The computer-readable medium of claim 12, wherein retrieving participant profile data for an auction participant comprises retrieving buyer profile data, the buyer profile data comprising a list of auction items desired for purchase by a buyer.

15. The computer-readable medium of claim 12, wherein generating an output further comprises:
automatically analyzing the popularity index and the availability index for the auction item over the predetermined period;
if the popularity index is low and the availability index is high, then generating an alert for the auction participant to bid on the auction item; and
if the popularity index is high and the availability index is low, then generating an alert for the auction participant to offer the auction item for sale.

16. A method for utilizing auction parameter data to generate alerts for making an auction item transaction, comprising:
receiving the auction parameter data on a computer system, the auction parameter data associated with sales of the auction item over a predetermined period in at least one online auction hosted by one or more auction websites; and
in response to receiving the auction parameter data on the computer system, generating an alert for making a transaction with respect to the auction item.

17. The method of claim 16, wherein generating an alert for making a transaction with respect to the auction item comprises generating at least one of a bid alert and a sell alert for the auction item.

18. The method of claim 17, wherein generating at least one of a bid alert and a sell alert for the auction item comprises:
calculating a popularity index for the auction item based on the auction parameter data;
calculating an availability index for the auction item based on the auction parameter data; and
analyzing the popularity index and the availability index for the auction item over the predetermined period.

19. The method of claim 18 further comprising determining if the popularity index is low and the availability index is high and, if so, then generating the bid alert, the bid alert comprising a recommendation for an auction participant to bid on the auction item.

20. The method of claim 18 further comprising determining if the popularity index is high and the availability index is low and, if so, then generating the sell alert, the sell alert comprising a recommendation for the auction participant to offer the auction item for sale.
